(19) United States
(12) Patent Application Publication
(10) Pub. No.: US 2007/0131874 A1
(43) Pub. Date: Jun. 14, 2007

(54) Scintillator materials which are useful for detecting radiation, and related methods and articles

(75) Inventors: Alok Mani Srivastava, Niskayuna, NY (US); Holly Ann Comanzo, Niskayuna, NY (US); Steven Jude Duclos, Clifton Park, NY (US); Lucas Lemar Clarke, Uniontown, OH (US); William Winder Beers, Chesterland, OH (US); Qun Deng, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/301,232

(22) Filed: Dec. 12, 2005

(51) Int. Cl. G01J 1/58

(52) U.S. Cl. 250/458.1

(57) ABSTRACT

A scintillator composition is described, including a matrix material and an activator. The matrix material includes at least one alkali metal or thallium; at least one alkaline earth metal or lead; and at least one halide compound. The activator is usually cerium, praseodymium, or mixtures thereof. Radiation detectors which include the scintillator composition are also described. Methods for detecting high-energy radiation also form part of this disclosure.

### BACKGROUND OF THE INVENTION

The invention described herein relates generally to luminescent materials. In some specific embodiments, the invention is directed to scintillator compositions which are especially useful for detecting gamma-rays and X-rays under a variety of conditions.

Scintillator materials are in common use as a component of radiation detectors for gamma-rays, X-rays, cosmic rays, and particles characterized by an energy level of greater than about 1 keV. The scintillator crystal is coupled with a light-detection means, i.e., a photodetector. When photons from a radionuclide source impact the crystal, the crystal emits light. The photodetector produces an electrical signal proportional to the number of light pulses received, and to their intensity.

The scintillators have been found to be useful for applications in chemistry, physics, geology, and medicine. Specific examples of the applications include positron emission tomography (PET) devices; well-logging for the oil and gas industry, and various digital imaging applications. Scintillators are also being investigated for use in detectors for security devices, e.g., detectors for radiation sources which may indicate the presence of radioactive materials in cargo containers.

For all of these applications, the composition of the scintillator is critical to device performance. The scintillator must be responsive to X-ray and gamma ray excitation. Moreover, the scintillator should possess a number of characteristics which enhance radiation detection. For example, most scintillator materials must possess high light output, short decay time, high “stopping power”, and acceptable energy resolution. (Other properties can also be very significant, depending on how the scintillator is used, as mentioned below).

Various scintillator materials which possess most or all of these properties have been in use over the years. Examples include thallium-activated sodium iodide (NaI(Tl)); bismuth germanate (BGO); cerium-doped gadolinium orthosilicate (GSO); cerium-doped lutetium orthosilicate (LSO); and cerium-activated lanthanide-halide compounds. Each of these materials have properties which are very suitable for certain applications. However, many of them also have some drawbacks. The common problems are low light yield, physical weakness, and the inability to produce large-size, high quality single crystals. Other drawbacks are also present. For example, the thallium-activated materials are very hygroscopic, and can also produce a large and persistent after-glow, which can interfere with scintillator function. Moreover, the BGO materials frequently have a slow decay time. On the other hand, the LSO materials are expensive, and may also contain radioactive lutetium isotopes which can also interfere with scintillator function.

In general, those interested in obtaining the optimum scintillator composition for a radiation detector have been able to review the various attributes set forth above, and thereby select the best composition for a particular device. (As but one example, scintillator compositions for well-logging applications must be able to function at high temperatures, while scintillators for PET devices must often exhibit high stopping power). However, the required overall performance level for most scintillators continues to rise with the increasing sophistication and diversity of all radiation detectors.

It should thus be apparent that new scintillator materials would be of considerable interest, if they could satisfy the ever-increasing demands for commercial and industrial use. The materials should exhibit excellent light output. They should also possess one or more other desirable characteristics, such as relatively fast decay times and good energy resolution characteristics, especially in the case of gamma rays. Furthermore, they should be capable of being produced efficiently, at reasonable cost and acceptable crystal size.

### BRIEF DESCRIPTION OF THE INVENTION

One embodiment of the present invention is directed to a scintillator composition which comprises the following, and any reaction products thereof:
(a) a matrix material, comprising:
   (i) at least one element selected from the group consisting of alkali metals and thallium;
   (ii) at least one element selected from the group consisting of alkaline earth metals and lead;
   (iii) at least one halide selected from the group consisting of bromine, iodine, and chlorine; and
(b) an activator for the matrix material, comprising cerium, praseodymium, or a mixture of cerium and praseodymium.

Another embodiment relates to a radiation detector for detecting high-energy radiation. The detector comprises the crystal scintillator mentioned above, along with a photodetector optically coupled to the scintillator. The device is thereby capable of producing an electrical signal in response to the emission of a light pulse produced by the scintillator.

A method for detecting high-energy radiation with a scintillation detector constitutes another embodiment of this invention. The method comprises the following steps:

(A) receiving radiation by a scintillator crystal having the composition described herein, so as to produce photons which are characteristic of the radiation; and

(B) detecting the photons with a photon detector coupled to the scintillator crystal.

Other features and advantages will be apparent from a review of the following detailed description of the invention.

### BRIEF DESCRIPTION OF THE DRAWINGS

FIG. 1 is a graph of the emission spectrum (under X-ray excitation), for a scintillator composition according to an embodiment of the present invention.

### DETAILED DESCRIPTION OF THE INVENTION

Component (i) of the matrix material for the scintillator comprises at least one element selected from the group consisting of alkali metals and thallium. The alkali metal can be sodium, potassium, rubidium, or cesium. Cesium is sometimes the most preferred alkali metal. Moreover, many different combinations of alkali metals—with or without thallium—could also be used. A non-limiting example is a combination of cesium and potassium.

Component (ii) of the matrix material comprises at least one element selected from the group consisting of alkaline earth metals and lead. The alkaline earth metal can be magnesium, calcium, strontium, or barium. In some embodiments, barium is the most preferred alkaline earth metal. Moreover, many different combinations of alkaline earth metals—with or without lead—could also be used.

The relative proportions of component (i) (alkali metals/thallium) and (ii) (alkaline earth metals/lead) can vary considerably. Usually, the proportions will depend on stoichiometric considerations, such as valence, atomic weight, chemical bonding, coordination number, the amount of halide present; and the like.

In some embodiments, the matrix material may further comprise bismuth. The presence of bismuth can enhance various properties, like stopping power. The amount of bismuth (when present) can vary to some extent. Usually, bismuth would be present at a level of about 1 mole % to about 40 mole % of the total molar weight of the matrix material (i.e., component (a)), including the bismuth itself. In preferred embodiments, the level of bismuth is about 5 mole % to about 20 mole %.

The halide of component (iii) is usually bromine, iodine, or chlorine. Each of the individual halides may be useful for certain applications. As an illustration, in some embodiments, iodine is especially preferred, in view of one or more properties enhanced by its inclusion, e.g., light output and stopping power. In other embodiments, chlorine may be preferred because it is less hygroscopic than bromine or iodine, although the light output values for some chlorine-based scintillator compositions are significantly lower than those based on the other halides.

Moreover, in other embodiments, various combinations of halides may be present. Thus, the matrix material can be in the form of a solid solution of at least two halides (e.g., bromine and iodine), and components (i) and (ii). As used herein, the term “solid solution” refers to a mixture of the components in solid, crystalline form, which may include a single phase, or multiple phases. (Those skilled in the art understand that phase transitions may occur within a crystal after its formation).

Some specific families of scintillators for particular embodiments can also be described. For example, the scintillator matrix could comprise a compound of the formula
Cs₂βX₄ or Csβ₂X₅,

wherein β is at least one element selected from the group consisting of alkaline earth metals and lead; and X is bromine, iodine, chlorine, or various mixtures of any of the foregoing. For other embodiments, the scintillator matrix could comprise a compound of the formula
A₂BaX₄ or ABa₂X₅,

wherein A is at least one element selected from the group consisting of alkali metals and thallium; and X is as described previously. (As alluded to above, the relative amounts of alkali metal/thallium to alkaline earth metal/lead for these specific examples of scintillators, as well as the other more general families described previously, can vary by as much as about 10 atomic % from stoichiometric proportions. In some cases, the variation from stoichiometric proportions could be even greater).

Non-limiting examples of specific matrix compositions for the scintillator are as follows: Cs₂BaBr₄, Cs₂BaI₄, CsBa₂Br₅, CsBa₂I₅, and CsBa₂(Br_{0.5}Cl_{0.45}I_{0.05})₅. Additional examples include Cs₂Ba(Br₁₋ₓIₓ)₄; CsBa₂(Br₁₋ₓIₓ)₅; and (CsₓK₁₋ₓ)Ba₂Br₅, wherein 0.01≦x≦0.99.

An activator for the matrix material is also present in these compositions. (The activator is sometimes referred to as a “dopant”). The preferred activator is selected from the group consisting of cerium, praseodymium, and mixtures of cerium and praseodymium. In terms of luminescence efficiency and decay time, cerium is often the most preferred activator. It is usually employed in its trivalent form, Ce⁺³. The activator can be supplied in various forms, e.g., halides like cerium chloride or cerium bromide.

The appropriate level of activator will depend on various factors, such as the particular halide, group (i) element, and group (ii) element present in the matrix; the desired emission properties and decay time; and the type of detection device into which the scintillator is being incorporated. Usually, the activator is employed at a level in the range of about 0.1 mole % to about 20 mole %, based on total moles of activator and matrix material. In many preferred embodiments, the amount of activator is in the range of about 1 mole % to about 10 mole %.

The scintillator compositions of this invention are usually described in terms of a matrix material component and an activator component. However, it should be understood that when the components are combined, they can be considered as a single, intimately-mixed composition, which still retains the attributes of activator and component. Thus, for example, an illustrative composition in which the alkali metal is cesium; the alkaline earth metal is barium; the halide is bromine; and the activator is cerium, could be expressed by a single chemical formula, such as
Cs(Ba_{0.98}Ce_{0.02})₂Br₅.

The scintillator composition may be prepared and used in various forms. In some preferred embodiments, the composition is in monocrystalline (i.e., “single crystal”) form. Monocrystalline scintillator crystals have a greater tendency for transparency. They are especially useful for high-energy radiation detectors, e.g., those used for gamma rays.

The scintillator composition can be used in other forms as well, depending on its intended end use. For example, it can be in powder form. It should also be understood that the scintillator compositions may contain small amounts of impurities, as described in the previously-referenced publications, WO 01/60944 A2 and WO 01/60945 A2 (incorporated herein by reference). These impurities usually originate with the starting materials, and typically constitute less than about 0.1% by weight of the scintillator composition. Very often, they constitute less than about 0.01% by weight of the composition. The composition may also include parasitic additives, whose volume percentage is usually less than about 1%. Moreover, minor amounts of other materials may be purposefully included in the scintillator compositions.

In some (though not all) embodiments, the scintillator compositions are substantially free of lanthanum. Lanthanum may contain a small amount of one or more long-decay, radioactive isotopes. These isotopes result in a background count rate that can interfere with sensitive detector applications.

A variety of techniques can be used for the preparation of the scintillator compositions. (It should be understood that the compositions may also contain a variety of reaction products of these techniques). Usually, a suitable powder containing the desired materials in the correct proportions is first prepared, followed by such operations as calcination, die forming, sintering, and/or hot isostatic pressing. The powder can be prepared by mixing various forms of the reactants (e.g., salts, halides, or mixtures thereof). In some cases, individual constituents are used in combined form. (They may be commercially available in that form, for example). As an illustration, various halides of the alkali metals and alkaline earth metals could be used. Non-limiting examples include compounds such as barium iodide, cesium chloride, potassium bromide, cesium bromide, cesium iodide, thallium iodide, lead bromide, strontium chloride, and the like.

The mixing of the reactants can be carried out by any suitable techniques which ensure thorough, uniform blending. For example, mixing can be carried out in an agate mortar and pestle. Alternatively, a blender or pulverization apparatus can be used, such as a ball mill, a bowl mill, a hammer mill, or a jet mill. Conventional precautions usually must be taken to prevent the introduction of any air or moisture during mixing. The mixture can also contain various additives, such as fluxing compounds and binders. Depending on compatibility and/or solubility, various liquids can sometimes be used as a vehicle during milling. Suitable milling media should be used, e.g., material that would not be contaminating to the scintillator, since such contamination could reduce its light-emitting capability.

After being blended, the mixture can then be fired under temperature and time conditions sufficient to convert the mixture into a solid solution. These conditions will depend in part on the specific type of matrix material and activator being used. The mixture is usually contained in a sealed vessel (e.g., a tube or crucible made of quartz or silver) during firing, so that none of the constituents are lost to the atmosphere). Usually, firing will be carried out in a furnace, at a temperature in the range of about 500° C. to about 1500° C. The firing time will typically range from about 15 minutes to about 10 hours. Firing is usually carried out in an atmosphere free of oxygen and moisture, e.g., in a vacuum, or using an inert gas such as nitrogen, helium, neon, argon, krypton, and xenon. After firing is complete, the resulting material can be pulverized, to put the scintillator into powder form. Conventional techniques can then be used to process the powder into radiation detector elements.

In the case of single crystal materials, preparation techniques are also well-known in the art. A non-limiting, exemplary reference is “Luminescent Materials”, by G. Blasse et al, Springer-Verlag (1994). Usually, the appropriate reactants are melted at a temperature sufficient to form a congruent, molten composition. The melting temperature will depend on the identity of the reactants themselves, but is usually in the range of about 650° C. to about 1100° C.

A variety of techniques can be employed to prepare a single crystal of the scintillator material from a molten composition. They are described in many references, such as U.S. Pat. No. 6,437,336 (Pauwels et al); “Crystal Growth Processes”, by J. C. Brice, Blackie & Son Ltd (1986); and the “Encyclopedia Americana”, Volume 8, Grolier Incorporated (1981), pages 286-293. These descriptions are incorporated herein by reference. Non-limiting examples of the crystal-growing techniques are the Bridgman-Stockbarger method; the Czochralski method, the zone-melting method (or “floating zone” method), and the temperature gradient method. Those skilled in the art are familiar with the necessary details regarding each of these processes.

U.S. Pat. No. 6,585,913 (Lyons et al; incorporated herein by reference) provides some useful information for one method of producing a scintillator in single crystal form. In this method, a seed crystal of the desired composition (described above) is introduced into a saturated solution. The solution is contained in a suitable crucible, and contains appropriate precursors for the scintillator material. The new crystalline material is allowed to grow and add to the single crystal, using one of the growing techniques mentioned above. The size of the crystal will depend in part on its desired end use, e.g., the type of radiation detector in which it will be incorporated.

Another embodiment of the invention is directed to a method for detecting high-energy radiation with a scintillation detector. The detector includes one or more crystals, formed from the scintillator composition described herein. Scintillation detectors are well-known in the art, and need not be described in detail here. Several references (of many) which discuss such devices are U.S. Pat. Nos. 6,585,913 and 6,437,336, mentioned above, and U.S. Pat. No. 6,624,420 (Chai et al), which is also incorporated herein by reference. In general, the scintillator crystals in these devices receive radiation from a source being investigated, and produce photons which are characteristic of the radiation. The photons are detected with some type of photodetector (“photon detector”). (The photodetector is connected to the scintillator crystal by conventional electronic and mechanical attachment systems).

The photodetector can be a variety of devices, all well-known in the art. Non-limiting examples include photomultiplier tubes, photodiodes, CCD sensors, and image intensifiers. Choice of a particular photodetector will depend in part on the type of radiation detector being fabricated, and on its intended use.

The radiation detectors themselves, which include the scintillator and the photodetector, can be connected to a variety of tools and devices, as mentioned previously. Non-limiting examples include well-logging tools and nuclear medicine devices (e.g., PET). The radiation detectors may also be connected to digital imaging equipment, e.g., pixilated flat panel devices. Moreover, the scintillator may serve as a component of a screen scintillator. For example, powdered scintillator material could be formed into a relatively flat plate which is attached to a film, e.g., photographic film. High energy radiation, e.g., X-rays, originating from some source, would contact the scintillator and be converted into light photons which are developed on the film. Furthermore, the radiation detectors may also be used for security devices. For example, they could be used to detect the presence of radioactive materials in cargo containers.

Several of the specific end use applications can be described here in more detail, although many of the relevant details are known to those skilled in the art. Well-logging devices were mentioned previously, and represent an important application for these radiation detectors. The technology for operably connecting the radiation detector to a well-logging tube is well-understood. The general concepts are described in U.S. Pat. No. 5,869,836 (Linden et al), which is incorporated herein by reference. The crystal package containing the scintillator usually includes an optical window at one end of the enclosure-casing. The window permits radiation-induced scintillation light to pass out of the crystal package for measurement by the light-sensing device (e.g., the photomultiplier tube), which is coupled to the package. The light-sensing device converts the light photons emitted from the crystal into electrical pulses that are shaped and digitized by the associated electronics. By this general process, gamma rays can be detected, which in turn provides an analysis of the rock strata surrounding the drilling bore holes. It should be emphasized, however, that many variations of well-logging devices are possible.

Medical imaging equipment, such as the PET devices mentioned above, represent another important application for these radiation detectors. The technology for operably connecting the radiation detector (containing the scintillator) to a PET device is also well-known in the art. The general concepts are described in many references, such as U.S. Pat. No. 6,624,422 (Williams et al), incorporated herein by reference. In brief, a radiopharmaceutical is usually injected into a patient, and becomes concentrated within an organ of interest. Radionuclides from the compound decay and emit positrons. When the positrons encounter electrons, they are annihilated and converted into photons, or gamma rays. The PET scanner can locate these “annihilations” in three dimensions, and thereby reconstruct the shape of the organ of interest for observation. The detector modules in the scanner usually include a number of “detector blocks”, along with the associated circuitry. Each detector block may contain an array of the scintillator crystals, in a specified arrangement, along with photomultiplier tubes. As in the case of well-logging devices, many variations on PET devices are possible.

The light output of the scintillator is critical for both the well-logging and PET technologies. The present invention can provide scintillator materials which possess the desired light output for demanding applications of the technologies. Moreover, it is possible that the crystals can simultaneously exhibit some of the other important properties noted above, e.g., short decay time, high “stopping power”, and acceptable energy resolution. Furthermore, the scintillator materials can be manufactured economically. They can also be employed in a variety of other devices which require radiation detection.

### EXAMPLES

The example which follows is merely illustrative, and should not be construed to be any sort of limitation on the scope of the claimed invention. A 2 gram sample of a cerium-activated scintillator composition was prepared in this example. The matrix portion of the composition had the formula CsBa₂Br₅. To prepare the sample, 0.5273 grams of CsBr, 1.4431 grams of BaBr₂, and 0.0376 grams of CeBr₃ were weighed in a glove box. The materials were thoroughly blended, and then sealed in a silver tube. Firing was carried out at about 800° C. for 5 hours, under an inert atmosphere. The nominal formula for the composition after firing was Cs(Ba_{0.98}Ce_{0.02})Br₅.

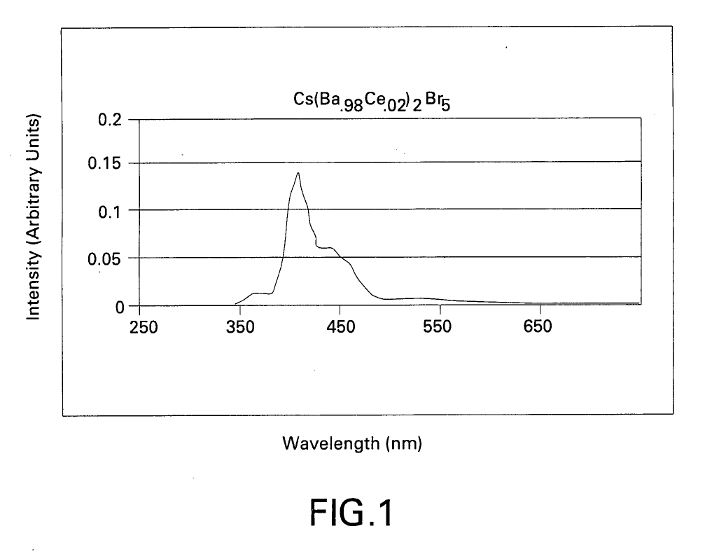

The emission spectrum for the sample was determined under X-ray excitation, using an optical spectrometer. FIG. 1 is a plot of wavelength (nm) as a function of intensity (arbitrary units). The peak emission wavelength for the sample was about 400 nm. It was also determined that the scintillator composition can be excited by gamma rays, to an emission level which is characteristic of the cerium ion. These emission characteristics are a clear indication that the compositions described herein would be very useful for a variety of devices employed to detect gamma rays.

It will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent publications, and other references mentioned above are incorporated herein by reference.

What is claimed:

1. A scintillator composition, comprising the following, and any reaction products thereof:
(a) a matrix material, comprising:
(i) at least one element selected from the group consisting of alkali metals and thallium;
(ii) at least one element selected from the group consisting of alkaline earth metals and lead;
(iii) at least one halide selected from the group consisting of bromine, chlorine, and iodine; and
(b) an activator for the matrix material, comprising cerium, praseodymium, or a mixture of cerium and praseodymium.

2. The scintillator composition of claim 1, wherein the alkali metal of component (i) is selected from the group consisting of sodium, potassium, rubidium, cesium, and mixtures thereof.

3. The scintillator composition of claim 1, wherein the alkaline earth metal of component (ii) is selected from the group consisting of magnesium, calcium, strontium, barium, and mixtures thereof.

4. The scintillator composition of claim 1, wherein the activator is present at a level in the range of about 0.1 mole % to about 20 mole %, based on total moles of activator and matrix material.

5. The scintillator composition of claim 1, wherein the matrix material comprises a compound of the formula
Cs₂βX₄ or Csβ₂X₅,
wherein β is at least one element selected from the group consisting of alkaline earth metals and lead; and X is selected from the group consisting of bromine, chlorine, iodine, and combinations thereof.

6. The scintillator composition of claim 5, wherein β is barium.

7. The scintillator composition of claim 1, wherein the matrix material comprises a compound of the formula
A₂BaX₄ or ABa₂X₅,
wherein A is at least one element selected from the group consisting of alkali metals and thallium; and X is selected from the group consisting of bromine, chlorine, iodine, and combinations thereof.

8. The scintillator composition of claim 1, wherein the matrix material comprises at least one compound selected from the group consisting of Cs₂BaBr₄, Cs₂BaI₄, CsBa₂Br₅, CsBa₂I₅, Cs₂Ba(Br₁₋ₓIₓ)₄; CsBa₂(Br₁₋ₓIₓ)₅; and (CsₓK₁₋ₓ)Ba₂Br₅, wherein 0.01≦x≦0.99.

9. The scintillator composition of claim 1, wherein the matrix material further comprises bismuth.

10. The scintillator composition of claim 9, wherein the bismuth is present at a level of about 1 mole % to about 40 mole % of the total molar weight of component (a).

11. A radiation detector for detecting high-energy radiation, comprising:
(A) a crystal scintillator which comprises the following composition, and any reaction products thereof:
(a) a matrix material, comprising:
(i) at least one element selected from the group consisting of alkali metals and thallium;
(ii) at least one element selected from the group consisting of alkaline earth metals and lead;
(iii) a halide selected from the group consisting of bromine, chlorine, iodine, and combinations thereof; and
(b) an activator for the matrix material, comprising cerium, praseodymium, or a mixture of cerium and praseodymium.
(B) a photodetector optically coupled to the scintillator, so as to be capable of producing an electrical signal in response to the emission of a light pulse produced by the scintillator.

12. The radiation detector of claim 11, wherein the matrix material of component (A) comprises a compound of the formula
Cs₂βX₄ or Csβ₂X₅,
wherein β is at least one element selected from the group consisting of alkaline earth metals and lead; and X is selected from the group consisting of bromine, chlorine, iodine, and combinations thereof.

13. The radiation detector of claim 12, wherein β is barium.

14. The radiation detector of claim 11, wherein the matrix material comprises a compound of the formula
A₂BaX₄ or ABa₂X₅,
wherein A is at least one element selected from the group consisting of alkali metals and thallium; and X is selected from the group consisting of bromine, chlorine, iodine, and combinations thereof.

15. The radiation detector of claim 11, wherein the matrix material comprises at least one compound selected from the group consisting of Cs₂BaBr₄, Cs₂BaI₄, CsBa₂Br₅, CsBa₂I₅, Cs₂Ba(Br₁₋ₓIₓ)₄; CsBa₂(Br₁₋ₓIₓ)₅; and (CsₓK₁₋ₓ)Ba₂Br₅, wherein 0.01≦x≦0.99.

16. The radiation detector of claim 11, wherein the matrix material of component (a) further comprises bismuth.

17. The radiation detector of claim 11, wherein the photodetector is at least one device selected from the group consisting of a photomultiplier tube, a photodiode, a CCD sensor, and an image intensifier.

18. The radiation detector of claim 11, operably connected to a well-logging tool.

19. The radiation detector of claim 11, operably connected to a nuclear medicine apparatus.

20. The radiation detector of claim 19, wherein the nuclear medicine apparatus comprises a positron emission tomography (PET) device.

21. The radiation detector of claim 11, operably connected to a device for detecting the presence of radioactive materials in cargo containers.

22. A method for detecting high-energy radiation with a scintillation detector, comprising the steps of:
(A) receiving radiation by a scintillator crystal, so as to produce photons which are characteristic of the radiation; and
(B) detecting the photons with a photon detector coupled to the scintillator crystal;
wherein the scintillator crystal is formed of a composition comprising the following, and any reaction products thereof:
(a) a matrix material, comprising:
(i) at least one element selected from the group consisting of alkali metals and thallium;
(ii) at least one element selected from the group consisting of alkaline earth metals and lead;
(iii) a halide selected from the group consisting of bromine, chlorine, iodine, and combinations thereof; and
(b) an activator for the matrix material, comprising cerium, praseodymium, or a mixture of cerium and praseodymium.

23. The method of claim 22, wherein the alkali metal of component (i) is selected from the group consisting of sodium, potassium, rubidium, cesium, and mixtures thereof.

24. The method of claim 22, wherein the alkaline earth metal of component (ii) is selected from the group consisting of magnesium, calcium, strontium, barium, and mixtures thereof.

25. The method of claim 22, wherein the activator is present at a level in the range of about 0.1 mole % to about 20 mole %, based on total moles of activator and matrix material.

26. The method of claim 22, wherein the scintillation detector is operably connected to a device selected from the group consisting of a well-logging tool; a nuclear medicine apparatus; and an apparatus for detecting the presence of radioactive materials in cargo containers.
